(19) United States
(12) Patent Application Publication
(10) Pub. No.: US 2016/0267608 A1
(43) Pub. Date: Sep. 15, 2016

(54) PESTICIDE AND CROP TREATMENT APPLICATION LABEL AND MAXIMUM RESIDUE LEVEL COMPLIANCE CHECKING SYSTEM AND METHOD

(71) Applicant: AGRIAN, INC., FRESNO, CA (US)

(72) Inventors: TODD S. RICKETS, FRESNO, CA (US); NISHAN MAJARIAN, FRESNO, CA (US)

(21) Appl. No.: 15/068,419

(22) Filed: Mar. 11, 2016

Related U.S. Application Data
(60) Provisional application No. 62/132,781, filed on Mar. 13, 2015.

(51) Int. Cl. G06Q 50/02; G06Q 30/00

(52) U.S. Cl. CPC G06Q 50/02; G06Q 30/018

(57) ABSTRACT

A pesticide application label and maximum residue level checking framework determines whether a crop is safe to be harvested, when it can be harvested, and in which potential export markets the crop can be sold after harvest. The pesticide application label and maximum residue level checking framework includes processes for checking treatment label specifications and rules for maximum residue levels for active ingredients in treatments applied to crops during a growing season. A process for evaluating harvest and regulatory compliance, and a pesticide application label and maximum residue level evaluation system, are also disclosed.

### CROSS-REFERENCE TO RELATED PATENT APPLICATION(S)

This patent application claims priority to U.S. provisional application 62/132,781, filed on Mar. 13, 2015, the contents of which are incorporated in their entirety herein. In accordance with 37 C.F.R. §1.76, a claim of priority is included in an Application Data Sheet filed concurrently herewith.

### FIELD OF THE INVENTION

The present invention relates to food safety and regulatory compliance for crops and fields. Specifically, the present invention relates to a system and method of performing pesticide application label and maximum residue level compliance checking, for evaluating a crop treatment and its impact on harvest of the crop and export to potential markets.

### BACKGROUND OF THE INVENTION

Crop treatments such as pesticides are useful for reducing crop damage due to pests, and for improving crop yields. However, there are limits as to the level of residues of active ingredients in pesticides that may safely remain on produce, or grain, or other commodities produced from crops. These limits are expressed as the Maximum Residue Level (MRL) for a given active ingredient.

The United States sets MRLs for numerous active ingredients. Non-U.S. markets also set MRLs for active ingredients. The U.S. and non-U.S. MRLs are often set at different levels, and treating crops with an appropriate amount of active ingredient for one country or jurisdiction does not necessarily mean that the crops are appropriately treated for others. There are a great many pesticides and country combinations, making the decision-making process for food companies extremely difficult. In some cases, there is no defined MRL for an active ingredient.

Growers often rely upon crop advisors to assist them in solving the problem of what pesticides or other treatments are best suited for a given crop and given pest, and what levels of such crop treatments may be applied prior to harvest, while remaining compliant with a given market's MRLs. A commercial database, such as one provided by Bryant Christie (BC), may be accessed to assist in making crop recommendations. BC characterizes the MRL rules for many active ingredients and for many countries and makes them available in a database.

In one example, a grower may wish to grow strawberries in the U.S. for export to Australia and Japan. The crop advisor would have to 1) be aware of each intended market, 2) research allowable pesticide residue levels for each market, 3) determine whether pesticide is allowable at all, 4) determine an allowable amount to be applied, and 5) determine a minimum time between applications and harvesting (pre-harvest interval). At the same time, failure to keep active ingredient residue levels within allowable limits may result in crops being denied entry into intended markets. There is no currently-available system or method for reliably determining what pesticides or other treatments to apply to a crop, and what levels of such crop treatments may be applied prior to harvest. There is also no currently-available system for monitoring crop treatment applications and active ingredient residue levels that keep abreast of MRL rules for different markets so that a crop output commodity remains within specified MRL values for all of the crop's intended export markets.

### BRIEF SUMMARY OF THE INVENTION

It is one objective of the present invention to provide a system and method of evaluating harvest and regulatory compliance issues for one or more treatments applied to a crop. It is another objective of the present invention to combine checking treatment application labels and maximum residue level rules for a crop in an intended export market. It is yet another objective of the present invention to provide a pesticide application label and maximum residue level evaluation service. It is still another objective of the present invention to provide a framework for determining if a crop is safe to be harvested, when it should be harvested, and if it can be sold in an export market, where one or more crop treatments are applied to the crop during a growing season.

The present invention is a label and rules compliance checking platform for agricultural implementations. The present invention performs checking functions on both crop treatment application labels, and rules for maximum residue levels (MRLs) for active ingredients in crop treatments in export markets in which a crop will be sold, to ensure crop safety and regulatory compliance. These checking functions are performed within a pesticide application label and maximum residue level checking framework, and the systems and methods described herein further embodying the present invention. These include a process of evaluating harvest and regulatory compliance for one or more pesticides applied to a crop, and a pesticide application label and maximum residue level evaluation system, each having a plurality of components and steps for accomplishing the functions, elements, and objectives described herein.

These checking functions for treatment application labels, and rules for maximum residue levels (MRLs) for active ingredients, enable a recommendation writing aspect of the present invention which provides meaningful information for crop advisors. These recommendations inform growers and other responsible entities regarding the use of crop treatments and whether a crop can be safely harvested, as well as when it can be harvested. These recommendations also inform growers and other responsible entities regarding whether a commodity from the crop output can be sold in export markets.

Other objects, embodiments, features, and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWING

The accompanying drawing, which is incorporated in and constitutes a part of this specification, illustrates several embodiments of the invention and together with the description, serves to explain the principles of the invention.

FIG. 1 is a block diagram of components of a pesticide application label and maximum residue level checking framework according to one aspect of the present invention; and

FIG. 2 is a diagram of a process of evaluating harvest and regulatory compliance for pesticides and other crop treatments applied to a crop according to another aspect of the present invention.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

The present invention is a pesticide application label and maximum residue level (MRL) checking framework 100, embodied in one or more systems and methods that evaluate harvest and regulatory compliance for one or more treatments 102 applied to a crop 104 in a field 106, and write crop advisor recommendations 152 for one or more users. The present invention is comprised of several components for performing the above objectives in the systems and methods disclosed herein.

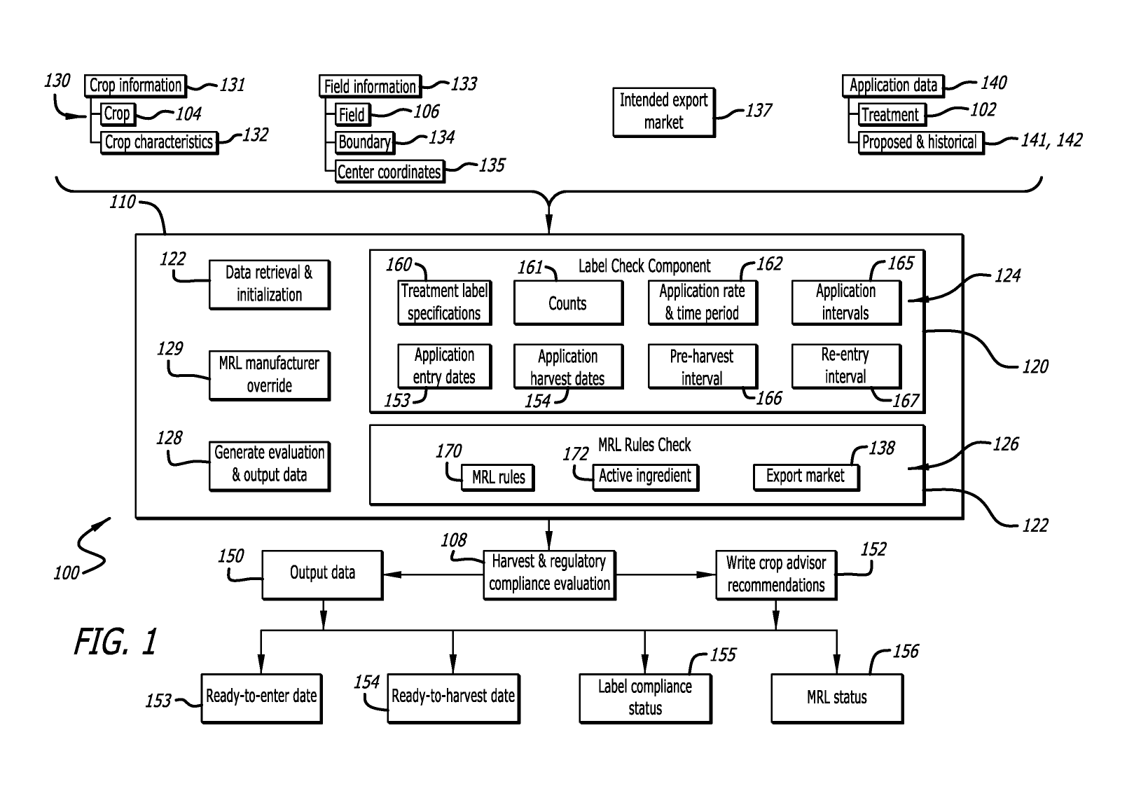

FIG. 1 is a block diagram illustrating various elements and components of the pesticide application label and MRL checking framework 100. The present invention is performed within a computing environment 110 that is comprised of hardware and software components include at least one processor 112, one or more data processing modules 120, and may further include one or more servers. The at least one processor 112 is configured to execute program instructions that process input data 130 of various types, and carry out analytical functions and mathematical processes that produce a harvest and regulatory compliance evaluation 108 and output data 150 as described further herein.

The data processing components 120 may include a data retrieval and recommendation initialization component 122 that is configured to receive, request, retrieve, obtain, or otherwise acquire input data 130 and distribute the input data 130 to the various other components 110 within the pesticide application label and MRL checking framework 100. The data retrieval and recommendation initialization component 122 is also configured to arrange the input data 130 for the pesticide application label and MRL checking framework 100, and initialize the process of writing the one or more crop advisor recommendations 152.

The data processing components 120 also include several rules processing components, which together perform the analytical functions and mathematical processes described further herein. These include a label checking component 124, and a maximum residue level (MRL) checking component 126. These rules processing components return the harvest and regulatory compliance evaluation 108. One or more additional components 128 are configured to generate output data 150, such as the crop advisor recommendations 152. The data processing components 120 may further include a MRL manufacturer override component 127, configured to determine whether a manufacturer override for crop treatment 102 applies for the one or more intended export markets 138.

A harvest and regulatory compliance evaluation 108 is data generated as an output of the label checking component 124 and the maximum residue level checking component 126 that defines whether a crop 104 can safely be harvested, when it can be harvested, and into which export markets 138 a commodity output of the crop 104 can be sold. The harvest and regulatory compliance evaluation 108 is therefore the result of both the label checking component 124 and MRL checking component 126, and may serve as the basis for writing one or more recommendations 152 to a crop advisor. The harvest and regulatory compliance evaluation 108 can be generated during a recommendation writing process (such as for proposed application data 141) in a pre-application label and MRL check, or can be based solely on historical application data 142 in a post-application label and MRL check.

The present invention contemplates that many types of input data 130 may incorporated into the pesticide application label and MRL checking framework 100, and are within the scope of the present invention. For example, the pesticide application label and MRL checking framework 100 may apply crop information 131 that identifies one or more crop characteristics 132 of a crop 104 to which one or more treatments 102 may be applied. The crop information 131 may include data such as a crop type, an intended end use, and a crop output commodity form. The intended end use includes an identification of the post-harvest use of the crop 104, for example for human consumption (such as dry edible, edible, fresh, grain, juice, or processing uses) or for animal feed. The crop output commodity form identifies whether the crop 104 is to be sold in its fresh form, a processed form, or in a dehydrated or dried form.

Input data 130 may also include field information 133, which may comprise data defining a field boundary 134, or center coordinates 135 of the field 106. Regardless, the geographical location of the field 106 may be derived from the data defining a field boundary 134 or the center coordinates 135. These may be represented in one or more GPS data points 136. The pesticide application label and MRL checking framework 100 may include a Global Positioning System (GPS), having components such as a GPS-enabled receiver, which detects signals relative to the field 106 and receives the one or more GPS data points 136 to compute the field's precise position on Earth. The GPS-enabled receiver may thereby extracts and determine the geographical location of the field 106 from one or both of the field boundary 134 and center coordinates 135 from the GPS data points 136. This field information 133 may then be used to access applicable treatment label specifications 160 for a particular geographical location that includes the field 106.

Input data 130 also includes market data 137, which define one or more intended export markets 138. The market data 138 identifies the countries, territories, or jurisdictions in which the harvested crop 104 is to be sold. Each of these may have a different maximum allowable residue level for active ingredients 172 in the one or more treatments 102, as discussed further herein, and therefore the pesticide application label and MRL checking framework 100 must know which export markets 138 the harvested crop 104 will be shipped to and provided for sale.

Input data 130 also includes application data 140 for the one or more crop treatments 102 applied to a crop 104 during a crop growing season. The application data includes treatment start dates and treatment completion dates, and may be applied for both historical treatment applications 141, and for proposed treatment applications 142. In each case, the application data includes information about a season 143, a start date 144 of a treatment application, an end/completion date 145 of a treatment application, a treatment application rate 146 per unit of area (for example, an acre or hectare of land), a treatment type 147, and a treatment method 148 (such as air, irrigation, or ground-based methods).

Treatments 102 may include any substance or input applied to a crop, soil, or seed, either before, during or after a growing season. Treatments 102 may include, but are not limited to, pesticides, nutrients, chemicals, biologicals, organisms, and animal by-products such as manure. Treatments 102 may be synthetic or non-synthetic, and/or organic or in-organic, and may be used for any number of purposes, such as for promoting or accelerating growth, improving crop yield, limiting or increasing root water intake, control pests and diseases, greening, or to provide nutrients to plants, soils, and roots during growth cycles. Where the treatment 102 is a soil or seed treatment, example of the treatment 102 may include an insecticide, a fungicide, a repellant, a fertilizer, and an adjuvant.

The present invention is configured, as noted above, to write crop advisor recommendations 152 based on the harvest and regulatory compliance evaluation 108 performed by the pesticide application label and MRL checking framework 100. The crop advisor recommendations 152 comprise one form of the output data 150, and may convey specific information to users of the pesticide application label and MRL checking framework 100. For example, the output data 150 may further include one or more of a ready-to-enter date 153, a ready-to-harvest date 154, a label compliance status 155, and a maximum residue level status 156 for the one or more intended export markets 138.

Each of the label checking component 124, and the maximum residue level checking component 126, execute a plurality of analytical functions and mathematical processes to perform their specific tasks within the pesticide application label and MRL checking framework 100. The label checking component 124 is configured to ascertain a first aspect of the harvest and regulatory compliance evaluation 108, by determining one or more crop and harvest characteristics from checking label treatment specifications 160. These characteristics at least include a timing of field entry, and a harvest timing, based on application counts 161, application rates 162, and application intervals 163 for the one or more treatments 102 applied to the crop 104.

The label checking component 124 performs a multi-step process to ascertain this first aspect of the harvest and regulatory compliance evaluation 108. This first aspect is ascertained by determining if the crop treatment 102 is allowed for the crop 104 and the intended market 138, the maximum rate per application of the crop treatment 102, and the maximum rate per time period. It is further determined by calculating the minimum number of days between applications of the crop treatments 102, and the maximum number of applications of the crop treatment 102 per specified period of time.

At the outset of this multi-step process, the label checking component 124 first identifies a regulatory market for the field 106 from the field information 133 using one or both of the field boundary data 134 or the center coordinates 135 (and, if applicable, using the one or more GPS data points 136), and then retrieves and initializes treatment label specifications 160 for crop treatment 102 for the identified regulatory market 138 and crop 104.

The label checking component 124 then compares application data 140 with treatment label specifications 160 that relates to an application rate 162 of the crop treatments 102 and an application interval 163 for each consecutive crop treatment 102 applied and representing a number of elapsed days between applied crop treatments 102. The label checking component 124 processes application data 140 in this comparison step by counting the unique instances of a crop treatment 102 applied to a crop 104, and summing all of the application counts 161 where there is more than one unique application for the crop treatment 102. The label checking component 124 also compiles a total application by summing the application rate 162 for the season, and calculates an application interval 163 by determining the elapsed number of days for each consecutive application of a crop treatment 102.

Then, for each crop treatment 102, the label checking component 124 determines, by comparison with the treatment label specifications 160, if the crop treatment 102 is permitted for the particular crop 104 or market 138. If no, an alert is triggered and the pesticide application label and MRL checking framework 100 returns a “not allowed” status. The label checking component 124 then determines if the application rate 162 exceeds the maximum rate per application. If yes, another alert is triggered.

The label checking component 124 then checks whether a total rate exceeds the maximum rate per time period, and if yes, another alert is triggered. The label checking component 124 then compares the application count 161 with crop treatment specifications 160 to determine if it exceeds the maximum number of applications of the crop treatment 102 per time period. For any triggered alert, the label compliance status 155 for crop 104 or field 106 is returned as a failed check, and an identification of the offending crop treatment 102 is provided to the user. If no alerts are triggered, then a label compliance status 155 of pass is returned, indicating that the crop 104 is safe for harvesting.

The label checking component 124 then proceeds by calculating a latest field entry date 153 and a latest harvest activity date 154 from treatment completion dates 145 and treatment label specifications 160 relating to pre-harvest and field re-entry intervals 166 and 167. This is performed by retrieving and initializing the historical application data 141 and the proposed application data 142 and, for each crop treatment 102, interval specifications that include the pre-harvest interval 166 and the field re-entry interval 167. This interval information is based on the regulatory market 138, the treated crop 104, the timing of the application of the crop treatment 102, the method of application, and the rate of application of the crop treatment 102.

For each application of the crop treatment 102, the label checking component 124 of the pesticide application label and MRL checking framework 100 calculates the application ready to enter date by summing the application completion date or time 145 with the re-entry interval 167. The label checking component 124 then calculates the application ready to harvest date by summing the application completion date or time 145 with the pre-harvest interval 166. From these calculations, the label checking component 124 then calculates the ready to enter date 153 as the latest application ready to enter date for all instantiations of the application data 140 for the crop treatment 102, and calculates the ready to harvest date 154 as the latest application ready to harvest date for all instantiations of the application data 140 for the crop treatment 102. The ready to enter date 153 and the ready to harvest date 154 together provide an indication in the harvest and regulatory compliance evaluation 108 as to when the crop 104 is to be harvested.

The maximum residue level checking component 126 is configured to ascertain a second aspect of the harvest and regulatory compliance evaluation 108, by evaluating an active ingredient residue limit 172 for crop treatments 102 to determine if the crop 104 is exportable to the one or more intended markets 138. The maximum residue level checking component 126 performs a multi-step process to ascertain this second aspect of the harvest and regulatory compliance evaluation 108.

This second aspect is ascertained by first accessing one or more maximum residue level rules 170 for each active ingredient 172 in the one or more treatments 102, and for each intended market 138. These maximum residue level rules 170 are most often supplied by manufacturers of the crop treatments 104, and are retrieved from one or more external database collections. The maximum residue level checking component 126 also retrieves additional information to initialize the multi-step MRL checking process. This include a listing of unique crop treatments 102, a list of potential export markets 138, a listing of all active ingredients 172 using the crop treatments 102, and MRL values for each active ingredient 172 in both a domestic market and all potential export markets 138.

The maximum residue level checking component 126 begins by determining an active ingredient MRL status for each potential export market 138. For each crop treatment 102, and for each active ingredient 172, the maximum residue level checking component 126 performs a look-up of the domestic MRL value and potential export markets 138 and first determines if there is an export market value. If there is no export market value, the maximum residue level checking component 126 returns an active ingredient market status as a “fail” and logs the active ingredient/crop treatment combination.

The maximum residue level checking component 126 then compares maximum allowable residue levels for each active ingredient 172 in each crop treatment 102 applied for the domestic market with the one or more intended markets 138, and determines if the domestic MRL value is higher or lower. If the domestic market value is greater than the intended export market value, the maximum residue level checking component 126 returns an active ingredient and MRL compliance status 156 as a “fail” and logs the active ingredient/crop treatment combination. If the domestic market value is equal to or less than the intended market value, the maximum residue level checking component 126 then a MRL compliance status 156 of “pass” is returned. For every instance that a “fail” status is returned, the override component 127 determines if a manufacturer override exists for a crop treatment 102 for the one or more intended markets 138.

The label checking component 124 and the maximum residue level checking component 126 together produce the harvest and regulatory compliance evaluation 108, which is used to initialize output data 150 in the one or more additional components 128. Crop advisor recommendations 152 are written in the one or more components 128 based on the harvest and regulatory compliance evaluation 108. The crop advisor recommendations 152, as noted above, comprise output data 150 and may convey specific information to users of the pesticide application label and MRL checking framework 100, such as the ready-to-enter date 153, the ready-to-harvest date 154, a label compliance status 155, and a maximum residue level status 156 for the one or more intended export markets 138. The crop advisor recommendations 152 may be written to and stored in one or more database collections for access by growers and other individuals or entities responsible for crop harvesting and regulatory compliance.

It is to be understood that the plurality of analytical functions and mathematical processes performed by one or both of the label checking component 124 and MRL rules checking component 126 may include many different approaches to developing the intended output information from the input data 130. For example, the present invention may analyze statistical probability models by applying one or more mathematical equations to the input data to calculate the application entry dates 153 and application harvest dates 154 from the re-entry interval 166 and pre-harvest interval 167, respectively. Other mathematical formulas and processes may be applied, such as transfer functions to determine a best-fit for a series of data points, a regression analysis, or other approaches to summarize relationships between multiple variables.

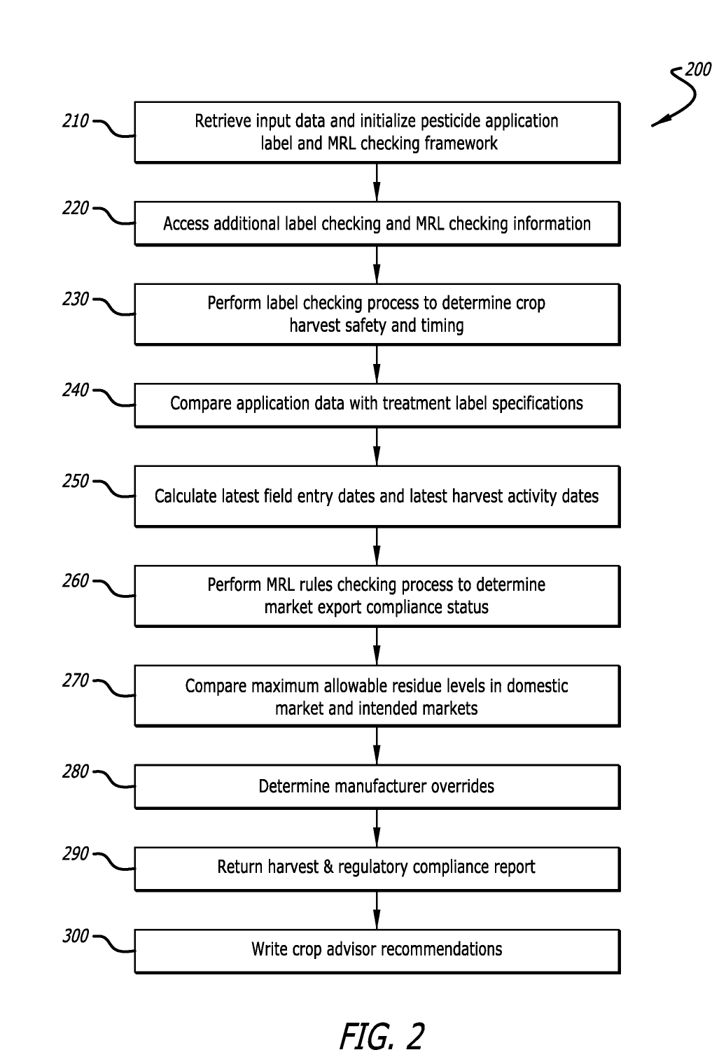

FIG. 2 is a diagram of a process 200 of evaluating harvest and regulatory compliance for use of a crop treatment 102 on a crop 104 and/or in a field 106, and for generating the output data 150, according to one aspect of the pesticide application label and MRL checking framework 100. In such a process 200, the present invention retrieves, requests, obtains, or otherwise acquires the input data 130, and initializes the pesticide application label and MRL checking framework 100 at step 210. Input data 130 retrieved includes crop information 131, application data 140 for one or more crop treatments 102 applied to a crop 104 during a crop growing season that at least includes treatment start dates and treatment completion dates, location information 133 for a field in which the crop is grown, and market data 137 identifying one or more intended markets 138 for the commodity output of the crop 104. This input data 130 is passed to the multiple analytical components described herein.

At step 220 of the process, any additional information for label checking and MRL checking is also accessed, such as the treatment label specifications 160, MRL rules 170, and listing of export markets serving as the one or more intended markets 138. At step 230, the process 200 performs a label check using the treatment label specifications 160 by comparing the application data 140 with treatment label specifications 160 at step 240, and calculating a latest field entry date and a latest harvest activity date from treatment completion dates and treatment label specifications at step 250.

The process 200 continues by performing a MRL rules check at step 260, by comparing, for each active ingredient 172 in each crop treatment 102 applied, maximum allowable residue levels relative to a domestic market and the one or more intended markets 138 at step 270. The process 200 then determines if any manufacturer overrides apply at step 280, and returns a harvest and regulatory compliance evaluation 108 at step 290 for crop treatments 102, that indicates if a crop 104 is safe for harvest, when it can be harvested, and whether MRL rules 170 for the one or more intended export markets 138 are satisfied. At step 300, the process 200 writes one or crop advisor recommendations 152 based on the harvest and regulatory compliance evaluation 108.

Many implementations of the pesticide application label and MRL checking framework 100 and the process 200 are possible, and contemplated as within the scope of the present invention, for both the label checking aspect and the MRL rules checking aspect, as well as the writing crop advisor recommendations. One such implementation is in a server environment that at least includes a MRL rules server and a crop advisor server. The MRL rules server may include a commercially-available database storing MRL rules 170. The MRL rules server may be accessed via a web service or API (Application Programming Interface). The crop advisor server may include a crop advisor database and a web server, and may be accessible by conventional web browsers over an Internet connection. It is to be understood that in this sever environment implementation, while specified in this paragraph as two separate servers, the server environment may be virtualized and co-located on the same physical server. Regardless, one or more servers may be accessed within the present invention for performing the pesticide application label and MRL checking framework 100 and the process 200.

In one exemplary embodiment involving such a server environment implementation, the present invention includes adding or updating label information in treatment label specifications 160 for crop treatments 102. In such an embodiment, a crop treatment manufacturer provides a new or updated label submission to the crop advisor server, such as via the Internet or other electronic means. The crop advisor server indexes the label information and messages the manufacturer processor when complete. The manufacturer then confirms to the crop advisor server that the label has been properly indexed.

The crop advisor server then communicates an updated label notification to the MRL rules server. The MRL rules server adds MRL rules 170, indexes the information, and messages the crop treatment manufacturer that indexing is completed. The crop treatment manufacturer then verifies the accuracy of the information indexed by the MRL rules server, and transmits a data approval message to the MRL rules server. The MRL rules server then messages the crop advisor server that label data and the MRL rules 170 are approved. The crop advisor server is then in a position to provide label data and MRL rules data to crop advisors, growers, or other responsible entities, and write recommendations 152 based on the output data 150.

The present invention may also be implemented in a computing environment 110 that permits crop advisors, growers, and other responsible entities to access information and make selections using graphical user interfaces configured on computing devices. For example, a crop advisor may access the crop advisor server from a web browser from any type of device, including but not limited to a desktop computer, laptop computer, tablet computer, wearable device, a “smart” phone, or any other mobile computing and/or telephony apparatus. The web browser may therefore be installed on any suitable hardware device configured with an Internet connection. Users may also access the graphical user interface-based tools from any location.

The crop advisor server in such an embodiment is configured to download forms and/or menu selections to the browser, which enables selection of a crop treatment 102 for application, a crop 104, a field 106, a crop output commodity, and market data 37 such as one or more intended markets 138, as well as a domestic market. The crop advisor server receives these selections and communicates label and market information to the MRL rules server. The MRL rules server may return a list of intended markets 138, active ingredients 172, and MRL(s) with flags and manufacturer's notes to the crop advisor server. The crop advisor server then presents the MRL rules data 170 to the crop advisor via the web browser. Those steps may be repeated to add additional markets.

The crop advisor server aggregates the export markets and MRL rules 170 to convey MRL information using the graphical user interface concerning the various export markets 138 to the crop advisor. The crop advisor server may organize this information for display in any number of ways. In one example of such a display of information, the crop advisor server may provide a product recommendation form that includes a plurality of tabbed menus, such as for example “Location Information”, “Application Details”, and others such as “Final Details”, “Extras”, and “Review”.

The “Application Details” tab may provide different windows within which a variety of menu selections. In an “Application” window, the crop advisor may select an application method, a spray volume, a tank size, an applicator, and also identify whether the application includes only nutrients. An “Add Product” window includes pull-down menus that enable crop advisors to make treatment-specific and crop-specific selections. For example, users may be able to select a particular crop treatment product 102, and identify a commodity for a crop output. Users may also be able to select a type of pest present, and application conditions, such as a rate, total used, inventory, and cost information.

MRL information may be presented in a separate window. This section may include both a Chemical View and a Market View, and data for multiple active ingredients 172 may be displayed in such views on the graphical user interface. All of this information may be saved as part of the recommendation writing process, and therefore crop advisor recommendations 152 may be presented to crop advisors in this exemplary manner.

Continuing with this graphical user interface implementation of the present invention, in the Chemical View crop treatment MRL information may be grouped by both crop treatment 102 and by active ingredient 172. For each combination of export market 138 and active ingredient 172, information may be displayed concerning crop output commodity categorization, crop output commodity type, market, MRL for that market, status and notes. If the crop treatment 102 would result in a residue level that exceeds the MRL for the active ingredient 172 in any market, a status field may include a symbol representing an alert, and the MRL value may be highlighted, for example in red typeface. As noted above, a manufacturer override may be specific, and the Chemical View may display such an override, as well as manufacturer's notes regarding the override.

Some selected crop treatments 102 may contain multiple active ingredients 172. In such cases, each active ingredient 172 may be displayed along with each MRL value for selected markets 138. In some cases, a crop output commodity may be delivered to markets 138 in different forms, e.g., fresh or dried basil leaves, and the Chemical View may be configured to display the MRL for each commodity form. An active ingredient 172 may also have no MRL value. In these situations, the Chemical View may display an alert and indicate that there is no MRL value.

The Chemical View may also be switched to a Market View, in which information is grouped by export market and crop output commodity. Within each grouping, each active ingredient 172 for the selected crop treatment 102 is listed, along with MRLs, type, crop output commodities, notes, and status. Where an intended use of a crop treatment 102 would exceed MRL values for a given intended market 138, the status is set to include an indicator, and the MRL values may be set to a typeface having a particular color.

The writing of crop advisor recommendations 152 within the present invention may therefore as be described as a process in which a customer, such as crop advisor, initially selects a crop treatment 102 to be applied in a field 106 or to a crop 104, by identifying input data 130. In a server environment implementation of the MRL rules checking component 126 of the present invention, this selection is communicated to the crop advisor server, which in turn sends label information and intended export market 138 to the MRL rules server. The MRL rules server returns the active ingredients 172, and the MRL rules 170 for intended export markets 138, with any flags and manufacturer notes. This MRL data—the MRL rules 170, active ingredients 172, and export markets 138—is then presented to the crop advisor. The crop advisor (or other user, such as a grower directly, or other responsible entity) may optionally add additional market data 137 at any time, as well as we identify other crop treatments 102, crops 104 and fields 106. The crop advisor may then save output data 150 as a recommendation 152, the content of which may be stored in a particular database collection for subsequent use.

Many other elements or embodiments are possible and are within the scope of the present invention. For example, the pesticide application label and MRL checking framework 100 may include an in-situ component that collects and analyzes data from a crop 104 during a growing season for the presence of residue resulting from an application of treatments 102 that are not include in treatment label specifications 160 or MRL rules 170. This may occur, for example, from crop treatments 102 that contain animal by-products such as animal manure or other animal product or by-product that could contain human pathogens. The pesticide application label and MRL checking framework 100 may therefore communicate such in-situ data to a laboratory for confirmation of the presence of such a residue, and integrate the results of such an analysis with the label checking component 124 and the MRL checking component 126.

It is to be further understood that the present invention may also be embodied in a software package, library, or other software-oriented component that provides all of the same functions within the pesticide application label and MRL checking framework 100 as described above. Alternatively, the present invention may be embodied in a hardware package, module, circuit board, chip, component, or other electronic hardware-oriented system that also provides all of these same functions. Such software and hardware each have multiple components capable of retrieving the data items necessary for practicing the present invention, and their timely updates. They also have multiple components capable of specifically performing the label checking, the MRL rules checking, and the recommendation writing aspects of the present invention.

The systems and methods of the present invention may be implemented in many different computing environments 110. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, non-transitory or otherwise, executed on programmed general-purpose computer with the cooperation of a controller and memory, a special purpose computer, a microprocessor, or the like. In these instances, the systems and methods of this invention can be implemented as a program embedded on personal computer such as an applet, JAVA.RTM or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
receiving, as input data, crop information, application data for one or more treatments applied to a crop during a crop growing season that at least includes a treatment start date and a treatment completion date, location information for a field in which the crop is grown, and one or more intended markets for the crop;
analyzing the input data in a plurality of data processing modules within a computing environment in which the plurality of data processing modules are executed in conjunction with at least one processor, the data processing modules configured to initialize one or more recommendations for the crop relative to the one or more treatments, by 1) performing a label check process configured to compare the application data with treatment label specifications relating to an application rate of the treatments and an application interval for each consecutive treatment applied and representing a number of elapsed days between treatments, and calculate a latest field entry date and a latest harvest activity date from the treatment completion date and treatment label specifications relating to pre-harvest and field re-entry intervals, and 2) performing a maximum residue level check process configured to compare, for each active ingredient in each of the one or more treatments applied, maximum allowable residue levels relative to a domestic market and the one or more intended markets, to return a harvest and regulatory compliance evaluation for the treatments applied to the crop; and
generating, as output data, a ready-to-enter date, a ready-to-harvest date, a label compliance status, and a maximum residue level status for the one or more intended markets from the harvest and regulatory compliance evaluation, in the one or more recommendations for the crop.

2. The method of claim 1, wherein the field location information includes at least one of field boundary data and field center coordinates, and wherein the crop information includes the crop currently being grown in the field, an intended end use of the crop including at least one of human consumption and animal feed, and a crop output commodity form that includes a fresh form and dried form.

3. The method of claim 2, further comprising accessing applicable treatment label specifications for a particular geographical location that includes the field, from the field location information.

4. The method of claim 1, further comprising obtaining the field location information for a particular geographical location from processing one or more GPS data points representing at least one of a field boundary and field center coordinates with a GPS receiver, and determining the geographical location of the field from the one or more GPS data points.

5. The method of claim 1, wherein the application data includes proposed application data that identifies at least one of a season, a proposed date of application, a method of application, a proposed one or more treatment to be applied, and a proposed application rate per unit of area.

6. The method of claim 1, wherein the application data includes historical application data that identifies at least one of a season, a date of application, a method of application, the one or more treatments applied, and an application rate per unit of area.

7. The method of claim 1, further comprising accessing one or more maximum residue level rules for each active ingredient in the one or more treatments, and for each intended market, from an external database collection.

8. The method of claim 1, further comprising determining a manufacturer override for the one or more treatments for the one or more intended markets.

9. The method of claim 1, wherein the field re-entry interval is an amount of time that must elapse after completion of the one or more treatments before a field can be safely entered, and the ready-to-enter date is the latest field entry date following a completion of the one or more treatments.

10. The method of claim 1, wherein the pre-harvest interval is an amount of time that must elapse after completion of the one or more treatments before the crop can be harvested, and the ready-to-harvest date is the latest harvest activity date following a completion of the one or more treatments.

11. A pesticide application label and maximum residue level evaluation system, comprising:
a computing environment including at least one non-transitory computer-readable storage medium having program instructions stored therein and a computer processor operable to execute the program instructions to return a harvest and regulatory compliance evaluation for one or more treatments applied to a crop within a plurality of data processing modules, the plurality of data processing modules including:
a data retrieval and recommendation initialization component configured to retrieve, store, and arrange input data that includes crop information, application data for the one or more treatments applied to the crop during a crop growing season that at least includes a treatment start date and a treatment completion date, location information for a field in which the crop is grown, and one or more intended markets for the crop;
a label check component configured to compare the application data with treatment label specifications relating to an application rate of the one or more treatments and an application interval for each consecutive treatment applied and representing a number of elapsed days between applied treatments, and calculate a latest field entry date and a latest harvest activity date from the treatment completion date and treatment label specifications relating to pre-harvest and field re-entry intervals;
a maximum residue level check component configured to compare, for each active ingredient in each of the one or more treatments applied, maximum allowable residue levels relative to a domestic market and the one or more intended markets; and
one or more components configured to generate at least one recommendation for the crop from the harvest and regulatory compliance evaluation, the at least one recommendation representing a ready-to-enter date, a ready-to-harvest date, a label compliance status, and a maximum residue level status for the one or more intended markets.

12. The system of claim 11, wherein the field location information includes at least one of field boundary data and field center coordinates, and wherein the crop information includes the crop currently being grown in the field, an intended end use of the crop including at least one of human consumption and animal feed, and a crop output commodity form that includes a fresh form and dried form.

13. The system of claim 12, wherein the label check module is further configured to access applicable treatment label specifications for a particular geographical location that includes the field, from the field location information.

14. The method of claim 11, wherein the data retrieval and recommendation initialization component is further configured to obtain the field location information for a particular geographical location by processing one or more GPS data points representing at least one of a field boundary and field center coordinates with a GPS receiver and determining the geographical location of the field from the one or more GPS data points.

15. The system of claim 11, wherein the application data includes proposed application data that identifies at least one of a season, a proposed date of application, a method of application, a proposed one or more treatment to be applied, and a proposed application rate per unit of area.

16. The system of claim 11, wherein the application data includes historical application data that identifies at least one of a season, a date of application, a method of application, the one or more treatments applied, and an application rate per unit of area.

17. The system of claim 11, wherein the data retrieval and recommendation initialization component is further configured to access, from an external database collection, one or more maximum residue level rules for each active ingredient in the one or more treatments, and for each intended market.

18. The system of claim 11, wherein the maximum residue level check module is further configured to determine a manufacturer override for the one or more treatments for the one or more intended markets.

19. The system of claim 11, wherein the field re-entry interval is an amount of time that must elapse after completion of the one or more treatments before a field can be safely entered, and the ready-to-enter date is the latest field entry date following a completion of the one or more treatments.

20. The system of claim 11, wherein the pre-harvest interval is an amount of time that must elapse after completion of the one or more treatments before the crop can be harvested, and the ready-to-harvest date is the latest harvest activity date following a completion of the one or more treatments.

21. A method of evaluating harvest and regulatory compliance for one or more treatments applied to a crop, comprising:
retrieving and initializing a plurality of input data, the plurality of input data including crop information, application data for one or more treatments applied to a crop during a crop growing season that at least includes a treatment start date and a treatment completion date, location information for a field in which the crop is grown, and one or more intended markets for the crop identifying an export market;
determining one or more crop and harvest characteristics that includes a field entry timing for each treatment and a harvest timing for the one or more treatments, to ascertain a first harvest and regulatory compliance component, by 1) comparing the application data with treatment label specifications relating to an application rate of the one or more treatments and an application interval for each consecutive treatment applied and representing a number of elapsed days between applied treatments, and 2) calculating a latest field entry date and a latest harvest activity date from the treatment completion date and treatment label specifications relating to pre-harvest and field re-entry intervals; and
evaluating an active ingredient residue limit for the one or more treatments on a harvested crop in the export market to determine if the crop is exportable to the export market, by 1) accessing one or more maximum residue level rules for each active ingredient in the one or more treatments, and for the export market, from an external database collection, 2) comparing for each active ingredient in each of the one or more treatment applied, maximum allowable residue levels relative to a domestic market and the export market, and 3) determining a manufacturer override for the one or more treatments for the export market; and
writing one or more crop advisor recommendations that include at least one of a ready-to-enter date, a ready-to-harvest date, a label compliance status, and a maximum residue level status for the one or more intended markets.

22. The method of claim 21, further comprising generating a harvest and regulatory compliance evaluation for the treatments applied to the crop.

23. The method of claim 21, wherein the field location information includes at least one of field boundary data and field center coordinates, and wherein the crop information includes the crop currently being grown in the field, an intended end use of the crop including at least one of human consumption and animal feed, and a crop output commodity form that includes a fresh form and dried form.

24. The method of claim 23, further comprising accessing applicable treatment label specifications for a particular geographical location that includes the field, from the field location information.

25. The method of claim 21, further comprising obtaining the field location information for a particular geographical location from processing one or more GPS data points representing at least one of a field boundary and field center coordinates with a GPS receiver, and determining the geographical location of the field from the one or more GPS data points.

26. The method of claim 21, wherein the application data includes proposed application data that identifies at least one of a season, a proposed date of application, a method of application, a proposed one or more treatment to be applied, and a proposed application rate per unit of area.

27. The method of claim 21, wherein the application data includes historical application data that identifies at least one of a season, a date of application, a method of application, the one or more treatments applied, and an application rate per unit of area.

28. The method of claim 21, wherein the field re-entry interval is an amount of time that must elapse after completion of the one or more treatments before a field can be safely entered, and the ready-to-enter date is the latest field entry date following a completion of the one or more treatments.

29. The method of claim 21, wherein the pre-harvest interval is an amount of time that must elapse after completion of the one or more treatments before the crop can be harvested, and the ready-to-harvest date is the latest harvest activity date following a completion of the one or more treatments.
